(19) United States
(12) Patent Application Publication
(10) Pub. No.: US 2015/0310221 A1
(43) Pub. Date: Oct. 29, 2015

(54) METHOD AND APPARATUS TO ROTATE DATA ENCRYPTION KEYS IN DATABASES WITH NO DOWN TIME

(71) Applicant: Intuit Inc., Mountain View, CA (US)

(72) Inventors: M. Shannon Lietz, San Marcos, CA (US); Luis Felipe Cabrera, Bellevue, WA (US); Sabu Kuruvila Philip, Redwood City, CA (US); Jay Schirmacher, San Diego, CA (US)

(73) Assignee: INTUIT INC., Mountain View, CA (US)

(21) Appl. No.: 14/263,808

(22) Filed: Apr. 28, 2014

(51) Int. Cl. G06F 21/62; G06F 17/30; H04L 9/08

(52) U.S. Cl. CPC G06F 21/6209; H04L 9/0891; G06F 17/30174

(57) ABSTRACT

A database includes a first instance and a second instance. The first and second instances of the database are encrypted with a first encryption key and have content that is synchronized. Database queries from a user computing device are directed to the first instance of the database. A third instance of the database is created from one of the existing two instances of the database. The third instance is decrypted from the first encryption key and is encrypted with a second encryption key. Database queries from the user computing device are redirected from the first instance of the database to the third instance of the database without interrupting service to the user computing device. The process is repeated by creating additional instances of the database, encrypting the additional instances with new encryption keys, and by redirecting database queries to the additional instances of the database.

### BACKGROUND

When electronic data is valued enough to be encrypted, computing systems are regularly configured to periodically change or rotate encryption keys to ensure continued security for the electronic data. Periodically changing encryption keys helps prevent the encryption keys, and their associated encrypted data, from being compromised. Thus, encryption keys are currently changed on a periodic or scheduled basis, and/or on an on-demand basis, e.g., in response to a lost or potentially compromised encryption key.

Changing encryption keys, using presently-known techniques, can have side-effects that make changing encryption keys undesirable. For instance, in order to change an encryption key that was used to encrypt data, the data first needs to be decrypted using the existing encryption key and then re-encrypted using a new encryption key. This process involves making the entirety of the encrypted data inaccessible for a period of time, resulting in live traffic interruptions.

Because of these side-effects, encryption keys are often changed less-frequently than is desired, e.g., for security purposes, in order to avoid interruption of live traffic. Unfortunately, when the encryption keys are changed less-frequently, the vulnerability of both the encryption keys and the encrypted data can be significantly higher.

What is needed is a method and system that allows encryption keys to be changed periodically without making the entirety of the encrypted data inaccessible for a significant period of time, e.g., by interrupting live traffic.

### SUMMARY

In accordance with one embodiment, a method and system for providing a rotating key encrypted database includes a process for providing uninterrupted access to a database while rotating encryption keys to the database whereby, in one embodiment, a first instance and a second instance of a database are encrypted with a first encryption key, and the first instance of the database is designated as a primary recipient of database queries from user computing devices.

In one embodiment, a third instance of the database is created by copying the first or second instance of the database. In one embodiment, copying includes restoring a snapshot copy or other backup copy of the first or second instance of the database. In one embodiment, the third instance of the database is decrypted from the first encryption key and is encrypted with a second encryption key. In one embodiment, the third instance of the database is designated as the primary recipient of database queries from user computing devices.

In one embodiment, additional instances of the database are repeatedly created, are repeatedly encrypted with new encryption keys, and each additional instance is designated as the primary recipient of database queries from the user computing devices.

### BRIEF DESCRIPTION OF THE DRAWINGS

FIGS. 1A-1C are block diagrams of a hardware architecture for implementing rotating encryption keys for a database, in accordance with one embodiment; and

FIG. 2 is a flow chart depicting a method for rotating encryption keys for a database, in accordance with one embodiment.

Common reference numerals are used throughout the FIG.s and the detailed description to indicate like elements. One skilled in the art will readily recognize that the above FIG.s are examples and that other architectures, modes of operation, orders of operation and elements/functions can be provided and implemented without departing from the characteristics and features of the invention, as set forth in the claims.

### DETAILED DESCRIPTION

Embodiments will now be discussed with reference to the accompanying FIG.s, which depict one or more exemplary embodiments. Embodiments may be implemented in many different forms and should not be construed as limited to the embodiments set forth herein, shown in the FIG.s, and/or described below. Rather, these exemplary embodiments are provided to allow a complete disclosure that conveys the principles of the invention, as set forth in the claims, to those of skill in the art.

According to various embodiments, the methods and systems disclosed herein enable encryption key rotation for a database without database downtime or interruption of database access. As discussed above, interrupting access to encrypted data can make the periodic rotation or change of encryption keys less desirable. However, executing an automated and policy-driven key distribution service for databases, as disclosed herein, can provide increased security to both encryption keys and encrypted data in an encrypted database. Initially, the system may provide a user with access to encrypted data by hosting a primary instance of a database and a mirror instance of the database. Both the primary instance of the database and the mirror instance of the database may be encrypted with an encryption key. The system may copy the mirror instance of the database to an additional computing device to create a third instance of the database. At that additional computing device, the system may decrypt the third instance of the database with the encryption key and re-encrypt the third instance of the database with a new encryption key. The system may then cause the primary database to fail over to the third instance of the database so that the third instance of the database becomes the primary instance of the database. In this manner, the system may rotate encryption keys for a database without interrupting user access to the database.

As used herein, the term “user” includes, but is not limited to, any party, parties, entity, and/or entities using, or otherwise interacting with any of the methods or systems discussed herein. For instance, in various embodiments, a user can be, but is not limited to, a person, a commercial entity, an application, a service, and/or a computing system.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically trusted computing environments are those where the assets, infrastructure, communication and networking systems, and security systems associated with the computing systems and/or virtual assets making up the trusted computing environment, are either under the control of, or known to, a party. In contrast, unknown, or untrusted computing environments are environments and systems where the assets, components, infrastructure, communication and networking systems, and security systems implemented and associated with the computing systems and/or virtual assets making up the untrusted computing environment, are not under the control of, and/or are not known by, a party, and/or are dynamically configured with new elements capable of being added that are unknown to the party.

In various embodiments, each computing environment includes allocated assets and virtual assets associated with, and controlled or used to create, and/or deploy, and/or operate an application.

Examples of trusted computing environments include the assets and components making up data centers associated with, and/or controlled by, an application and/or any computing systems and/or virtual assets, and/or networks of computing systems and/or virtual assets, associated with, known by, and/or controlled by, an application. Examples of untrusted computing environments include, but are not limited to, public networks, such as the Internet, various cloud-based computing environments, and various other forms of distributed computing systems.

It is often the case that to create, and/or deploy, and/or operate an application data must be transferred to, and/or from, a first computing environment that is an untrusted computing environment and a trusted computing environment. However, in other situations a party may wish to transfer data between two trusted computing environments, and/or two untrusted computing environments.

In one embodiment, one or more computing environments are connected by one or more communications channels, such as, but not limited to: any general network, communications network, or general network/communications network system; a cellular network; a wireless network; a combination of different network types; a public network; a private network; a satellite network; a POTS network; a cable network; or any other network capable of allowing communication between two or more computing systems, as discussed herein, and/or available or known at the time of filing, and/or as developed after the time of filing.

As used herein, the term “network” includes, but is not limited to, any network or network system such as, but not limited to, a peer-to-peer network, a hybrid peer-to-peer network, a Local Area Network (LAN), a Wide Area Network (WAN), a public network, such as the Internet, a private network, a cellular network, any general network, communications network, or general network/communications network system; a wireless network; a wired network; a wireless and wired combination network; a satellite network; a cable network; any combination of different network types; or any other system capable of allowing communication between two or more assets, virtual assets, and/or computing systems, whether available or known at the time of filing or as later developed.

As used herein the term “instance” can include either an occurrence, or sub-set, of an entity, such as a database instance, or a virtualized entity, such as a virtual server instance.

### Hardware Architecture

Herein, the term “production environment” includes the various components, or assets, used to deploy, implement, access, and use, a given application as that application is intended to be used. In various embodiments, production environments include multiple assets that are combined; communicatively coupled; virtually and/or physically connected; and/or associated with one another, to provide the production environment implementing the application.

As specific illustrative examples, the assets making up a given production environment can include, but are not limited to, one or more computing environments used to implement the application in the production environment such as a data center, a cloud computing environment, and/or one or more other computing environments in which one or more assets used by the application in the production environment are implemented; one or more computing systems or computing entities used to implement the application in the production environment; one or more virtual assets used to implement the application in the production environment; one or more supervisory or control systems, such as hypervisors or other systems used to monitor and control assets and/or components of the production environment; one or more communications channels for sending and receiving data used to implement the application in the production environment; one or more access control systems for limiting access to various components of the production environment, such as firewalls and gateways; one or more traffic and/or routing systems used to direct, control, and/or buffer, data traffic to components of the production environment, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the application in the production environment; one or more databases used to store data in the production environment; one or more internal or external services used to implement the application in the production environment; one or more backend systems, such as backend servers or other hardware used to process data and implement the application in the production environment; one or more software systems used to implement the application in the production environment; and/or any other assets/components making up an actual production environment in which an application is deployed, implemented, accessed, and run, e.g., operated, as discussed herein, and/or as known in the art at the time of filing, and/or as developed after the time of filing.

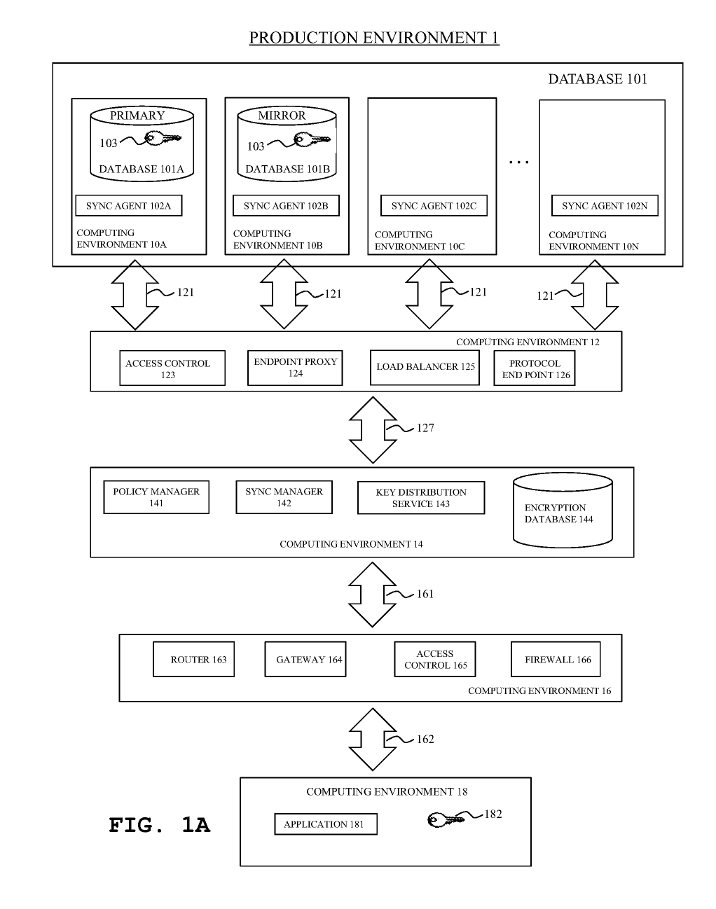

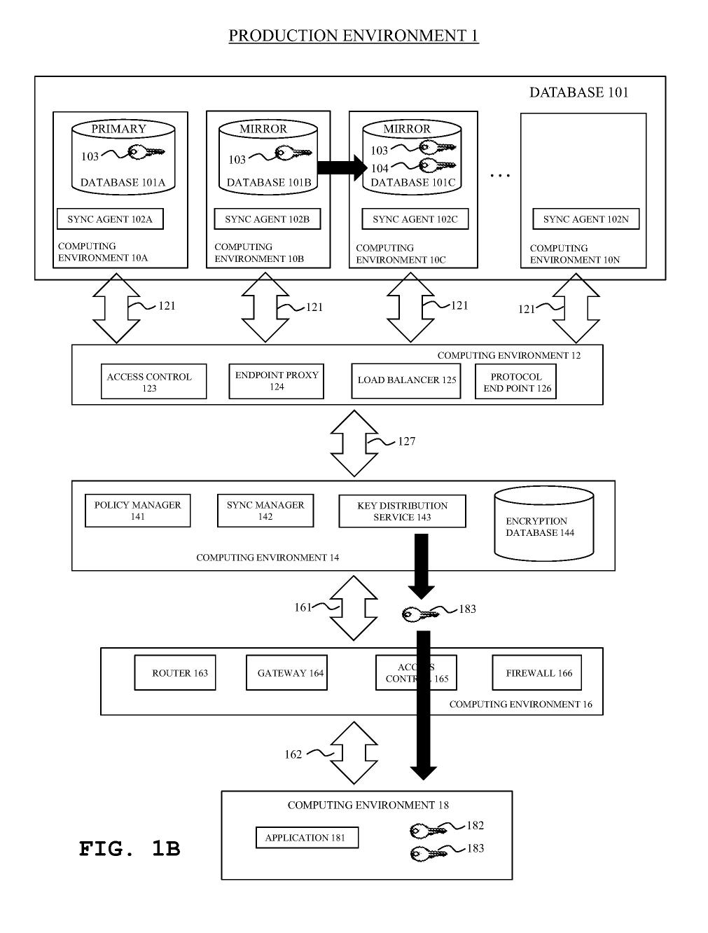

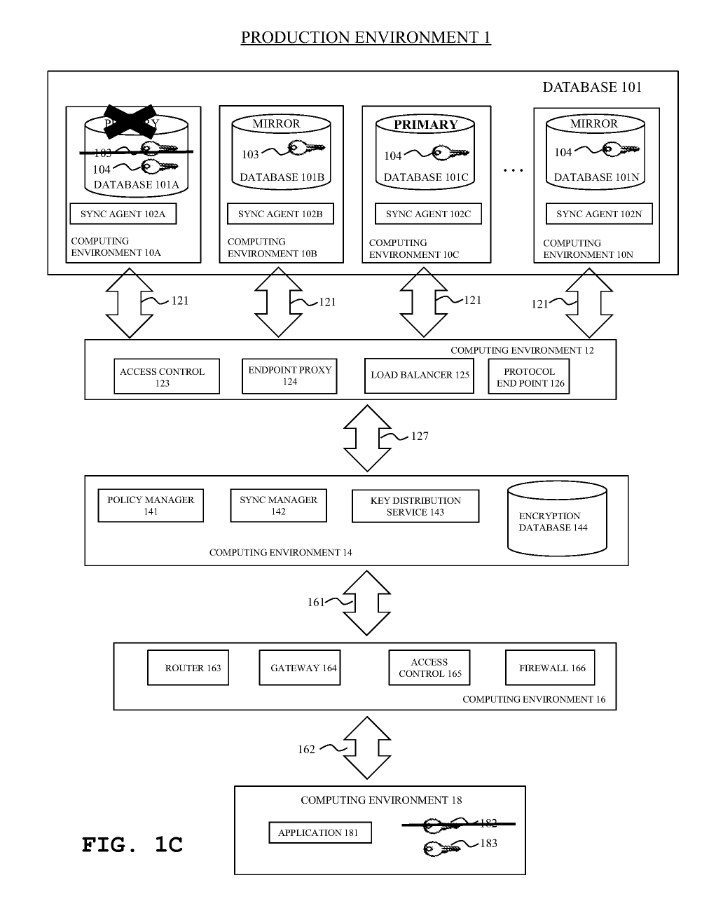

FIGS. 1A, 1B, and 1C illustrate views of a functional diagram of a production environment 1 that is configured to rotate, change, or update data encryption keys applied to a database, while concurrently providing uninterrupted access to the database for a user, according to one embodiment. The production environment 1 includes computing environments 10 (inclusive of 10A, 10B, 10C, . . . 10N), 12, 14, 16, and 18. These computing environments can be configured to selectively communicate information between one another to provide the user with database access. Embodiments of each of the computing environments 10, 12, 14, 16, and 18 are described below in turn.

Computing environments 10A-10N represent a number of computing devices that are configured to, or that are configurable to, host and/or maintain a database 101 (inclusive of database instances 101A, 101B, 101C, . . . 101N). The database 101 can be a data structure or other repository for storing, maintaining, and/or providing searchable and/or sortable data. In various embodiments, the database 101 (inclusive of database instances 101A, 101B, 101C, . . . 101N) is implemented, at least in part, in a cloud computing environment. In one particular implementation, the database 101 is configured to include or maintain sensitive data, such as, but not limited to, financial data to support one or more applications. The computing environment 10A may be configured to host the database instance 101A as a primary database instance that directly receives information from a user and directly provides information to the user, according to one embodiment. The computing environment 10B may be configured to host the database instance 101B as a mirror or secondary instance of the primary database instance 101A. The computing environments 10A and 10B may provide and maintain redundant instances of the database 101 to maintain responsiveness to high-volume queries and to provide fail-safe protection against the loss of any one of the computing environment 10A, the computing environment 10B, the database instance 101A, and the database instance 101B.

In various embodiments, one or more cloud computing environments are used to create, and/or deploy, and/or operate an application that can be any form of cloud computing environment, such as, but not limited to, a public cloud; a private cloud; a virtual private network (VPN); a subnet; a Virtual Private Cloud (VPC); a sub-net or any security/communications grouping; or any other cloud-based infrastructure, sub-structure, or architecture, as discussed herein, and/or as known in the art at the time of filing, and/or as developed after the time of filing.

In many cases, a given application or service may utilize, and interface with, multiple cloud computing environments, such as multiple VPCs, in the course of being created, and/or deployed, and/or operated.

Each of the computing environments 10 can be implemented in local or remote hardware, according to various embodiments. For example, one or more of the computing environments 10 may represent a single hard drive, a single computing device (e.g., with a local network), or a remotely located computing device, such as a cloud service or cloud computing device.

In one particular example implementation, one or more of the computing environments 10A is a virtual asset provided through a cloud computing service and/or environment. As used herein, the term “virtual asset” includes any virtualized entity or resource, and/or part of an actual, or “bare metal” entity. In various embodiments, the virtual assets can be, but are not limited to, virtual machines, virtual servers, and instances implemented in a cloud computing environment; databases associated with a cloud computing environment, and/or implemented in a cloud computing environment; services associated with, and/or delivered through, a cloud computing environment; communications systems used with, part of, or provided through, a cloud computing environment; and/or any other virtualized assets and/or sub-systems of “bare metal” physical devices such as mobile devices, remote sensors, laptops, desktops, point-of-sale devices, ATMs, electronic voting machines, etc., located within a data center, within a cloud computing environment, and/or any other physical or logical location, as discussed herein, and/or as known/available in the art at the time of filing, and/or as developed/made available after the time of filing.

In various embodiments, any, or all, of the assets making up a given production environment discussed herein, and/or as known in the art at the time of filing, and/or as developed after the time of filing, can be implemented as virtual assets.

Typically, virtual assets are created, or instantiated, using steps, instructions, processes, code, or “recipes” referred to herein as “virtual asset creation templates.” Typically, virtual assets that have the same, or similar, operational parameters are created using the same or similar “virtual asset creation templates.”

Examples of virtual asset creation templates include, but are not limited to, any tool and/or system for creating and managing a collection of related cloud resources. Illustrative examples of such a virtual asset creation template are any of the cloud formation templates/tools provided by Amazon Web Service (AWS), Rack Space, Joyent, and/or any other of the numerous cloud based infrastructure providers.

Other examples of virtual asset creation templates include, but are not limited to, any configuration management tool associated with, and/or used to create, virtual assets. One specific illustrative example of such a virtual asset creation template is a cookbook or recipe tool such as a Chef Recipe or system or any other fundamental element, or set of elements used to override the default settings on a node within an infrastructure or architecture.

Other examples of virtual asset creation templates include, but are not limited to, any virtual appliance used to instantiate virtual assets. One specific illustrative example of such a virtual asset creation template is an Amazon Machine Image (AMI), and/or similar functionality provided Amazon Web Service (AWS), Rack Space, Joyent, and/or any other of the numerous cloud based infrastructure providers.

Other examples of virtual asset creation templates include, but are not limited to, any appliance, or tool, or system, or framework, used to instantiate virtual assets as discussed herein, and/or as known/available in the art at the time of filing, and/or as developed/made available after the time of filing.

Herein virtual assets that have the same, or similar, operational parameters and are created by the same or similar virtual asset creation template are generically referred to as virtual assets of the same “class.” Examples of virtual asset classes include, but are not limited to, virtual machine classes; virtual server classes; virtual database or data store classes; self-monitoring virtual assets including specific types of instances instantiated in a cloud environment; application development process classes; and application classes.

The content of the database instances 101A and 101B may be synchronized with one another with a sync agent 102 (inclusive of sync agent instances 102A, 102B, 102C, . . . , 102N), according to one embodiment. The sync agent 102 may be a daemon or other computer program that runs in the background of one of, or each of, the computing environments 10. The sync agent 102 may pass messages between the computing environments 10 that include information about the changes made to each database instance. For example, the sync agent instance 102A may include instructions that enable the sync agent instance 102A to periodically query the database instance 101A for additions, deletions, or other changes made to the database instance 101A. The sync agent instance 102A may then transmit these changes to the sync agent instance 102B to enable the computing environment 10B to update the database instance 101B to include any changes that were made to the database instance 101A. In some embodiments, the sync agent 102 may include instructions to enable the sync agent 102 to perform event-driven updates in addition to or instead of periodic updates. For example, the sync agent instance 102A may be configured to transmit changes made to database instance 101A in response to the detection of any change being made to the database instance 101A. In this manner, the sync agent instance 102B, or other sync agent instances 102C-102N, may receive the information needed to update the other instances of the database 101, e.g., the database instance 101B.

The database instances 101A and 101B are encrypted with an encryption key 103, according to one embodiment. The encryption key 103 may be any one of a number of types of encryption keys, such as, but not limited to, public key infrastructure (“PKI”) encryption keys. In one example implementation, the encryption key 103 is a symmetric encryption key, so that encryption and decryption of data are both performed using the encryption key 103. In another example implementation, the encryption key 103 is one of an asymmetric encryption key pair, e.g., a private key or a public key, that may be used for encrypting the database 101 but that may not be used to decrypt the database 101. The encryption key 103, according to other example embodiments, may represent other encryption algorithms as well. The computing environments 10 may be configured to communicate with one another through computing environment 12.

The computing environment 12, e.g., an access control layer, may communicatively couple the computing environments 10 and the database 101 to the other computing environments within the production environment 1, according to one embodiment. In this specific illustrative example, computing environment 12 communicates with the computing environments 10 through communications channels 121. The computing environment 12 may provide access control layer features using assets such as exemplary access control systems, e.g., one or more of access control 123, endpoint proxy 124, load balancer 125, and protocol endpoint 126. The computing environment 12 may communicate with the computing environment 14 through the communications channel 127.

In one embodiment, two or more assets, such as computing systems and/or virtual assets, and/or two or more computing environments, are connected by one or more communications channels including but not limited to, Secure Sockets Layer communications channels and various other secure communications channels, and/or distributed computing system networks, such as, but not limited to: a public cloud; a private cloud; a virtual private network (VPN); a subnet; any general network, communications network, or general network/communications network system; a combination of different network types; a public network; a private network; a satellite network; a cable network; or any other network capable of allowing communication between two or more assets, computing systems, and/or virtual assets, as discussed herein, and/or available or known at the time of filing, and/or as developed after the time of filing.

The computing environment 14 may be configured to manage the rotation or update of encryption keys applied to the database 101, according to one embodiment. To maintain the security and/or confidentiality of information managed by the database 101, the database 101 can be encrypted with the encryption key 103. However, if the encryption key 103 is not changed, both the encryption key 103 and the contents of the database 101 may be subject to risk of theft, breach, compromise, unauthorized use, or the like. To maintain the security of encryption key 103 and database 101, the computing environment 14 may implement an encryption policy. To support implementation of the encryption policy, the computing environment 14 may include a policy manager 141, a sync manager 142, a key distribution service 143, and an encryption database 144.

The policy manager 141 maintains and implements an encryption policy to reduce the risk of compromise for the encryption keys or algorithms used for protecting the database 101. The encryption policy may include information such as types of encryption keys used, definitions for length of encryption keys, and the frequency with which encryption keys are to be rotated. Examples of types of encryption keys include asymmetric and symmetric; the length of the encryption key can, for example, vary in length from 50 bits to 1039 bits; and the frequency of encryption key rotation can be set, for example, to occur daily, weekly, bi-weekly, monthly, bi-monthly, quarterly, semi-annually, annually, bi-annually, or the like, according to various embodiments. The encryption policy may also include additional criteria that define when an encryption key is rotated. For example, the encryption policy may specify that an encryption key is rotated when one or more new users gain access to the database 101, when an IP address change is detected for one or more users, when a potential security breach is detected, or in response to key rotation instructions received from a system administrator.

The policy manager 141 may execute the encryption policy while continuing to provide uninterrupted user access to the database 101. As will be illustrated and described in more detail in FIG. 1B and FIG. 1C, the policy manager 141 may rotate an encryption key for the database 101 by creating a copy of the database in a new computing environment, decrypting the copy of the database with the current or aged/old encryption key in the new computing environment (e.g., computing environment 10C), encrypting the copy of the database with a new encryption key in the new computing environment, and directing users to the newly encrypted instance of the database in the new computing environment. In one embodiment, creating a copy of the database and a new computing environment includes creating a backup copy, e.g., a snapshot copy, of a mirror instance or of the primary instance of the database, and restoring the backup copy, e.g., snapshot copy, to the new computing environment. In other embodiments, the policy manager 141 provisions the new computing environment by, for example, instantiating or creating a database and directly copying the secondary instance or the primary instance of the database to the new computing environment. In yet other embodiments, the new computing environment establishes a direct connection with computing environment 10A or computing environment 10B, e.g., via a LAN, a peer-to-peer connection, or the like, to copy a primary instance or mirror instance of the database to the new computing environment.

To support execution of the encryption policy in the computing environment 14, the policy manager 141 may rely on the functions of the sync manager 142 and the key distribution service 143. For example, the sync manager 142 may be configured to synchronize the database instance 101B with the database instance 101A. The sync manager 142 may, according to one embodiment, synchronize database instance 101B with database instance 101A using the sync agent 102. In a specific example embodiment, the sync manager 142 may instruct the sync agent instance 102B to transmit changes associated with the database instance 101B to the other sync agent instances, and vice versa. When the policy manager 141 provisions a new computing environment, e.g., computing environment 10C, and creates a copy of the database 101 in the new computing environment, the sync manager 142 may be configured to ensure that the new database instance is synchronized with the other database instances, e.g., using sync agent instance 102C. In one embodiment, the new database instance is synchronized with at least one of the database instances 101A and 101B prior to the new instance going live, e.g., becoming accessible or available for access to a user.

The policy manager 141 may direct key distribution service 143 to distribute new encryption keys to users as new encryption keys are generated and used to encrypt the database 101. The key distribution service 143 may be configured to transmit new encryption keys to one or more user applications that are authorized to access one or more of the computing environments 10 and the database 101. As used herein, encryption keys also include decryption keys that are associated with particular encryption keys and that may be used to decrypt data that has been encrypted with particular encryption keys.

The policy manager 141 may use the encryption database 144 to execute the encryption policy, according to one embodiment. In particular, the policy manager 141 may store all or part of the encryption policy, encryption keys, identifiers for the computing environments 10, addresses for the computing environments 10, and other information in the encryption database 144. The policy manager 141, the sync manager 142, and the key distribution service 143 may each be communicatively coupled to the encryption database 144 to retrieve, update, and/or otherwise maintain the encryption database 144 with information useful for executing the encryption policy in the production environment 1, according to various embodiments.

Although illustrated and described as three separate components, in some embodiments, the policy manager 141 may also include the functionality of the sync manager 142 and the key distribution service 143. In other embodiments, functionality of the policy manager 141, the sync manager 142, and the key distribution service 143 may include more or less functionality that is described herein and may be incorporated in other components or modules within the computing environment 14.

The computing environment 16 facilitates communication between the computing environment 14 and the computing environment 18, according to one embodiment. The computing environment 16 may communicate with the computing environment 14 using communications channel 161, and the computing environment 16 may communicate with the computing environment 18 using communications channel 162. The computing environment 12 includes, as illustrative examples, one or more assets such as router 163, gateway 164, access control 165, and firewall 166. These assets, alone or in combination, may be configured to selectively provide the computing environment 18 with access to the computing environments 14 and 10. For example, the access control 165 and/or the firewall 166 may filter or screen communications from the computing environment 18 unless and until one or more passwords, codes, and authentication identifiers are received from the computing environment 18.

The computing environment 18 represents one or more user computing devices from which access to the database 101 may be requested, according to one embodiment. The computing environment 18 may include a single computing device, such as laptop, a netbook, a desktop, a smart phone, a tablet, or the like. In other embodiments, the computing environment 18 may include multiple computing devices communicatively coupled to one another via a LAN, a wireless area network (“WAN”), a personal area network (“PAN”), or the like. The computing environment 18 can include an application 181 and an encryption key 182.

The application 181 may enable a user to create, translate, and/or transmit database queries, modifications, and/or updates. For example, the application 181 may enable a user to query the database 101 for all financial data associated with the user for the year 2013. As another example, the application 181 may enable the user to upload financial data associated with the user for the years 2010-2013.

The computing environment 18 and/or the application 181 may be associated with the encryption key 182, according to one embodiment. The encryption key 182 may be used by the computing environment 18 and/or the application 181 to decrypt information received from the database 101. In some implementations, the encryption key 182 may be a symmetric encryption key associated with the encryption key 103. In other implementations, the encryption key 182 may be a public encryption key or private encryption key that is a public-private encryption key mate to the encryption key 103. In other words, encryption key 182 may correspond with the encryption key 103 and may be configured to be used by the computing environment 18 to decrypt information that has been encrypted by the encryption key 103. The encryption key 182 may also be configured to be used by a computing environment 18 to encrypt information that can be decrypted using the encryption key 103.

FIG. 1B illustrates the creation or provisioning of an additional instance of database 101 that is encrypted with a new encryption key, according to one embodiment. As discussed above, the policy manager 141 of the computing environment 14 may be configured to provision, initialize, or otherwise prepare computing environment 10C, e.g., an additional computing environment, to receive, maintain, and host the database instance 101C. The database instance 101C can be a copy of the database instance 101A or the database instance 101B, according to various embodiments. The policy manager 141 may create the database instance 101C by first creating a snapshot copy, a secondary copy, or other type of backup copy of the database 101 from the computing environment 10A or the computing environment 10B. The policy manager 141 may then restore the snapshot copy, the secondary copy, or the other type of backup copy of the database 101 to the computing environment 10C to create the database instance 101C. By creating the database instance 101C through the restoration of a backup copy, the policy manager 141 and the production environment 1 enable and/or provide continuous access to the primary and mirror instances of the database 101, e.g., uninterrupted access to the database instances 101A and/or 101B.

There are multiple advantages associated with a service provider being able to provide uninterrupted access to a user or customer to databases encrypted with automatically and periodically updated encryption keys. One advantage is that a service provider can advertise and deliver 24/7 access to user information. In today's global market, this translates to enabling clients to have access to their information or other database information at any time of the day regardless of the clients' geographic location. Another advantage is that the content of the databases and the encryption keys used to encrypt the databases are kept relatively more secure than databases or other information that is stagnantly encrypted, e.g., encrypted with an encryption keys or algorithms that are not updated very often. Yet another advantage is that automating the periodic rotation and/or updating of encryption keys reduces the human resources and costs that may have been historically associated with updating database encryption, and the opportunity for the introduction of human error.

After the policy manager 141 has created the database instance 101C in the computing environment 10C, the policy manager 141 may then provide instructions to the sync manager 142 to synchronize the database instance 101C with one or more of the other database instances 101A, 101B. As discussed previously, the sync manager 142 may synchronize different instances of the database 101 by causing the sync agent instances 102A, 102B, and 102C to send messages to each other that indicate changes or other modifications made to corresponding instances of the database 101. In some embodiments, the sync agent instances 102A, 102B, 102C may be configured to periodically transmit row, column, record, and/or table quantities for database instances 101A, 101B, and 101C to the other sync agents to confirm that the information in each of the database instances 101A, 101B, and 101C is synchronized with the information in the other database instances. Once the database instance 101C is created and synchronized in the computing environment 10C, the database instance 101C can be configured as a second mirror instance or copy of the database 101. In other words, the database instance 101C, in addition to the database instance 101B, can be a mirror copy of the primary database instance 101A and may be available for access by one or more users.

After the policy manager 141 generates, provides, or creates the database instance 101C in the computing environment 10C, the policy manager 141 may encrypt the database instance 101C with an encryption key 104. Prior to encrypting the database instance 101C with the encryption key 104, the policy manager 141 decrypts the database instance 101C using the encryption key 103 or the decryption key that corresponds to the encryption key 103. The policy manager 141 may decrypt that database instance 101C from the encryption key 103 and may encrypt the database instance 101C with the encryption key 104 by remotely accessing the computing environment 10C or by providing instructions to one or more applications residing on the computing environment 10C.

To enable the computing environment 18 and its corresponding one or more end users to access the content of the database instance 101C, the key distribution service 143 and/or the policy manager 141 transmits an encryption key 183 to the computing environment 18 to allow the user to decrypt the contents of the database instance 101C. Similar to the encryption key 182, the encryption key 183 may enable the user to decrypt the content of the database instance 101C and may also enable the user to encrypt information or messages that can be decrypted with the encryption key 104. In some implementations, the encryption key 183 is a symmetric encryption key counterpart to the encryption key 104. In other implementations, the encryption key 183 is a public encryption key or a private encryption key that constitutes a public-private encryption key pair with the encryption key 104. The encryption key 183 may represent other types of encryption keys that enable the user the computing environment 18 to decrypt and/or encrypt messages or information associated with the database instance 101C.

Because the computing environment 18 may include multiple encryption keys, such as encryption key 182 and encryption key 183, the computing environment 18 may be capable of accessing information from multiple instances of database 101, even though some instances are encrypted with encryption keys that are different than other instances. For example, the computing environment 18 may be configured to decrypt the content of the database instance 101A and the database instance 101B using the encryption key 182. Additionally, the computing environment 18 may be configured to decrypt the content of the database instance 101C using the encryption key 183. Accordingly, from the perspective of the computing environment 18, one primary instance of the database 101 and two mirror instances of the database 101 are accessible to the user in the production environment 1. Furthermore, based on the communications between the sync agent instances 102A, 102B, 102C and/or based on the instructions provided by the sync manager 142, each of the database instances 101A, 101B, 101C can be or are synchronized with each other instance of the database 101.

FIG. 1C illustrates the reassignment, reallocation, or re-designation of the primary instance of the database 101, according to one embodiment. After the policy manager 141 has re-encrypted the database instance 101C with the encryption key 104, and after the policy manager 141 or the sync manager 142 has synchronized the database instance 101C with database instance 101A and/or 101B, the policy manager 141 may cause the database instance 101A to fail over to the database instance 101C. In other words, the policy manager 141 may cause database query traffic coming from computing environment 18 to be primarily directed to the database instance 101C rather than primarily to the database instance 101A. At this time, the primary instance of the database 101 may be the database instance 101C and the mirror instances of the database 101 may be the database instances 101B and 101A. In some embodiments, the computing environment 10A can be decommissioned for receiving and transmitting database queries and database information to and from the computing environment 18. In other embodiments, the database instance 101B can serve as a mirror copy or secondary copy of the database 101 while another computing environment encrypts an instance of the database 101 with the encryption key 104. For example, while the database instance 101C serves as the primary instance of the database 101 and while the database instance 101B serves as the mirror instance of the database 101, the policy manager 141 can communicate instructions to the computing environment 10A to decrypt the database instance 101A from the encryption key 103 and can instruct the computing environment 10A to encrypt the database instance 101A with the encryption key 104. In an alternative embodiment, the policy manager 141 can create a snapshot copy or other backup copy of the database instance 101C, the database instance 101B, or the database instance 101A and restore the snapshot copy or other backup copy to, for example, the computing environment 10N to create the database instance 101N. If the database instance 101N is a restored version of a backup copy of the database instance 101C, then no further encryption may be needed until the next encryption key rotation. If, however, the database instance 101N is a restored version of a backup copy of the database instance 101A or 101B, then the database instance 101N may need to be decrypted from encryption key 103 and be encrypted with the encryption key 104, according to one embodiment. As a result, two instances of the database 101 can be encrypted with the encryption key 104 (e.g., database instance 101C and database instance 101A or 101N), and the database instance 101B can be decommissioned, discontinued, and/or abandoned.

In response to rotating encryption keys for a database 101, computing environment 14 may update the encryption database 144 to reflect the changes made to the computing environments 10 and to the instances of the database 101. For example, the policy manager 141 can update the encryption database 144 to reflect the use of the encryption key 104, to re-designate database instance 101C as the primary database instance, and to remove one or more computing environments or database instances that have been decommissioned or that are no longer in use, e.g., database instance 101B.

In response to rotating encryption keys for the database 101, computing environment 18 may update the encryption keys stored by the computing environment 18 to reflect the most recent encryption key used to encrypt the database 101. For example, rather than continuing to store the encryption key 182 and the encryption key 183, the computing environment 18 may delete, encrypt, or otherwise render the encryption key 182 unusable by an unauthorized third-party. By denying an unauthorized third-party access to both encryption keys used in the computing environment 18, unauthorized third parties may have a more difficult time determining the encryption key generation algorithm used by the policy manager 141. For these and other security reasons, the computing environment 18 may be configured to retain one or more encryption keys, e.g., encryption key 183, that are currently in use by the computing environments 10 and that are authorized for use by the policy manager 141.

### Process

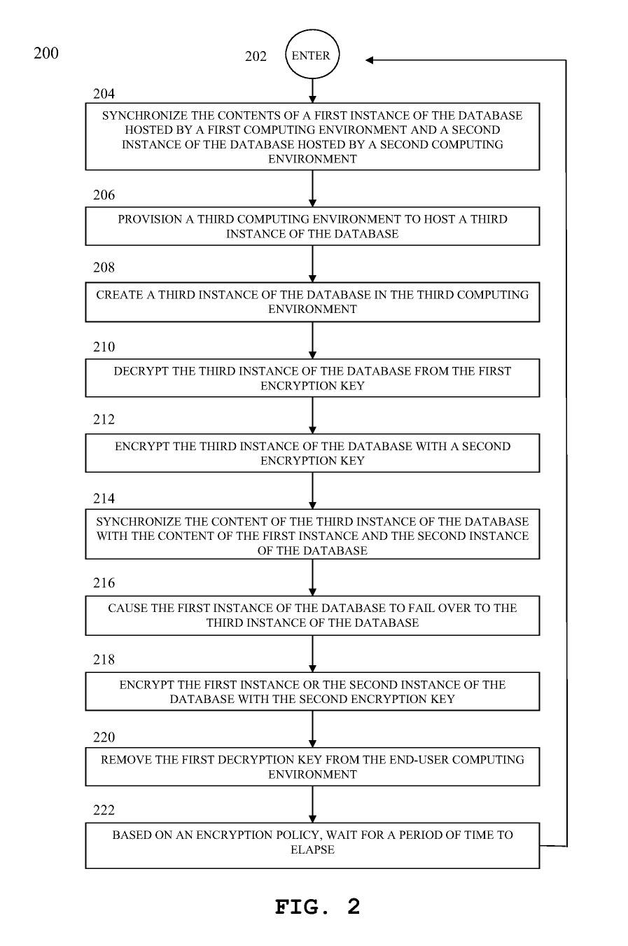

FIG. 2 describes a method 200 for providing uninterrupted database access and/or service to a user while rotating, changing, or updating database encryption keys, according to various embodiments.

At block 202, the method 200 begins.

At block 204, a policy management computing environment synchronizes the contents of a first or primary instance of the database and a second or mirror instance of the database. The first instance of the database may be hosted by a first computing environment, and the second instance of the database may be hosted by a second computing environment. The first instance and the second instance of the database are encrypted with a first encryption key. The policy management computing environments may transmit a first decryption key, which is associated with the first encryption key, to a user computing environment to enable the user computing environment to access the contents of the first instance of the database and/or the second instance of the database. In some embodiments, a single instance of the database is initially encrypted with the first encryption key.

At block 206, the policy management computing environment initializes or provisions a third computing environment to receive a copy or instance of the database. The policy management computing environment may initialize the third computing environment by allocating memory within the third computing environment, installing software, and by configuring network settings to enable the third computing environment to receive, maintain, and/or host an instance of the database.

At block 208, the policy management computing environment creates a third instance of the database in the third computing environment. In one embodiment, the policy management computing environment may create the third instance of the database by creating a backup copy, e.g., a snapshot, of the first instance or the second instance of the database, and restoring the backup copy of the first instance or the second instance of the database to the third computing environment. In alternative embodiments, the policy management computing environment may transfer a copy of the first instance or the second instance of the database to the third computing environment using any one of a number of other device-to-device data transfer techniques known to those of skill in the art.

At block 210, the policy management computing environment decrypts the new instance of the database to disassociate the third instance of the database from the first encryption key.

At block 212, the policy management computing environment encrypts the third instance of the database with a second encryption key that is different from the first encryption key. The policy management computing environment may then transmit a second decryption key, which is associated with the second encryption key, to the user computing environment to enable the user computing environment to query, modify, or otherwise access the content of the third instance of the database.

At block 214, the policy management computing environment synchronizes the contents of the third instance of the database with the content of the first instance of the database and the second instance of the database. Once the third instance of the database is synchronized, the third instance of the database may be accessible to the user computing environment as a second mirror instance to the first instance of the database.

At block 216, the policy management computing environment may cause the first or primary instance of the database to fail over to the third instance of the database so that the third instance of the database becomes the new primary instance of the database. In one embodiment, causing the first instance of the database to fail over to the third instance of the database includes redirecting primary database queries, requests, and updates to the third instance of the database. Accordingly, the policy management computing environment can rotate, change, or update database encryption keys or algorithms while concurrently providing uninterrupted user access to the contents of the database.

At block 218, the policy management computing environment encrypts the first instance of the database or the second instance of the database with the second encryption key. As was done with the third instance of the database, the policy management computing environment first decrypts the first instance or second instance of the database to disassociate the instance of the database from the first encryption key. After the first instance or second instance of the database is unencrypted, the policy management computing environment encrypts the unencrypted instance of the database with the second encryption key. After the first instance of the database or the second instance of the database is encrypted with the second encryption key, that instance of the database may serve as a mirror instance to the third instance of the database. In some embodiments, rather then re-encrypting the first instance of the database or the second instance of the database, the policy management computing environment provisions a fourth computing environment to host a fourth instance of the database that is encrypted with the second encryption key using the techniques described above for encrypting the third instance of the database with the second encryption key.

At block 220, the policy management computing environment may transmit instructions to the user computing environment to remove the first decryption key from the user computing environment. This security measure may prevent unauthorized acquisition or use of interactive or decommissioned versions of database encryption keys.

At block 222, the policy management computing environment monitors an encryption policy and returns to block 202 after a predetermined period of time expires to cycle or rotate the primary and mirror instances of the database to another, e.g., third, fourth, fifth, etc., encryption key, according to one embodiment.

As noted above, the specific illustrative examples discussed above are but illustrative examples of implementations of embodiments of the method or process for providing rotating-key encrypted databases. Those of skill in the art will readily recognize that other implementations and embodiments are possible. Therefore the discussion above should not be construed as a limitation on the claims provided below.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

Using the method 200 for providing a rotating key encrypted file system discussed herein, the risk of database data being compromised is significantly reduced by having the encryption keys periodically rotated for the instances of the database. As a result, even if the encryption key were compromised, the attacker is limited to a reduced window to gain access to the contents of the database.

In addition, using method 200 for providing a rotating key encrypted database discussed herein, performance and data accessibility are provided without interruption to user computing environments and systems. Consequently, using method 200 for providing a rotating key encrypted databases discussed herein, encryption keys can be changed more frequently interrupting live traffic.

As discussed in more detail above, using the above embodiments, with little or no modification and/or input, there is considerable flexibility, adaptability, and opportunity for customization to meet the specific needs of various parties under numerous circumstances.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

In addition, as used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

In the discussion above, certain aspects of one embodiment include process steps and/or operations and/or instructions described herein for illustrative purposes in a particular order and/or grouping. However, the particular order and/or grouping shown and discussed herein are illustrative only and not limiting. Those of skill in the art will recognize that other orders and/or grouping of the process steps and/or operations and/or instructions are possible and, in some embodiments, one or more of the process steps and/or operations and/or instructions discussed above can be combined and/or deleted. In addition, portions of one or more of the process steps and/or operations and/or instructions can be re-grouped as portions of one or more other of the process steps and/or operations and/or instructions discussed herein. Consequently, the particular order and/or grouping of the process steps and/or operations and/or instructions discussed herein do not limit the scope of the invention as claimed below.

The present invention has been described in particular detail with respect to specific possible embodiments. Those of skill in the art will appreciate that the invention may be practiced in other embodiments. For example, the nomenclature used for components, capitalization of component designations and terms, the attributes, data structures, or any other programming or structural aspect is not significant, mandatory, or limiting, and the mechanisms that implement the invention or its features can have various different names, formats, or protocols. Further, the system or functionality of the invention may be implemented via various combinations of software and hardware, as described, or entirely in hardware elements. Also, particular divisions of functionality between the various components described herein are merely exemplary, and not mandatory or significant. Consequently, functions performed by a single component may, in other embodiments, be performed by multiple components, and functions performed by multiple components may, in other embodiments, be performed by a single component.

Some portions of the above description present the features of the present invention in terms of algorithms and symbolic representations of operations, or algorithm-like representations, of operations on information/data. These algorithmic or algorithm-like descriptions and representations are the means used by those of skill in the art to most effectively and efficiently convey the substance of their work to others of skill in the art. These operations, while described functionally or logically, are understood to be implemented by computer programs or computing systems. Furthermore, it has also proven convenient at times to refer to these arrangements of operations as steps or modules or by functional names, without loss of generality.

Unless specifically stated otherwise, as would be apparent from the above discussion, it is appreciated that throughout the above description, discussions utilizing terms such as, but not limited to, “activating”, “accessing”, “adding”, “aggregating”, “alerting”, “applying”, “analyzing”, “associating”, “calculating”, “capturing”, “categorizing”, “classifying”, “comparing”, “creating”, “defining”, “detecting”, “determining”, “distributing”, “eliminating”, “encrypting”, “extracting”, “filtering”, “forwarding”, “generating”, “identifying”, “implementing”, “informing”, “monitoring”, “obtaining”, “posting”, “processing”, “providing”, “receiving”, “requesting”, “saving”, “sending”, “storing”, “substituting”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

The present invention also relates to an apparatus or system for performing the operations described herein. This apparatus or system may be specifically constructed for the required purposes, or the apparatus or system can comprise a general purpose system selectively activated or configured/reconfigured by a computer program stored on a computer program product as discussed herein that can be accessed by a computing system or other device.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

The present invention is well suited to a wide variety of computer network systems operating over numerous topologies. Within this field, the configuration and management of large networks comprise storage devices and computers that are communicatively coupled to similar or dissimilar computers and storage devices over a private network, a LAN, a WAN, a private network, or a public network, such as the Internet.

It should also be noted that the language used in the specification has been principally selected for readability, clarity and instructional purposes, and may not have been selected to delineate or circumscribe the inventive subject matter. Accordingly, the disclosure of the present invention is intended to be illustrative, but not limiting, of the scope of the invention, which is set forth in the claims below.

In addition, the operations shown in the FIG.s, or as discussed herein, are identified using a particular nomenclature for ease of description and understanding, but other nomenclature is often used in the art to identify equivalent operations.

Therefore, numerous variations, whether explicitly provided for by the specification or implied by the specification or not, may be implemented by one of skill in the art in view of this disclosure.

What is claimed is:

1. A computing system implemented method for providing uninterrupted access to a database while rotating encryption keys to the database, comprising:
encrypting, with at least one computing device, a first instance of the database with a first encryption key and a second instance of the database with the first encryption key,
wherein the second instance of the database is synchronized with the first instance of the database,
wherein the first instance of the database is designated as a primary recipient of database queries from user computing devices;
creating a third instance of the database by copying the first instance of the database or the second instance of the database,
wherein, upon creation, the third instance of the database includes contents that are encrypted with the first encryption key;
decrypting the third instance of the database to disassociate the contents of the third instance of the database from the first encryption key;
encrypting the third instance of the database with a second encryption key;
designating the third instance of the database as the primary recipient of database queries from user computing devices;
encrypting the first instance of the database or the second instance of the database with the second encryption key; and
decommissioning the first instance of the database or the second instance of the database that is not encrypted with the second encryption key.

2. The method of claim 1, further comprising:
synchronizing the third instance of the database with the first instance of the database prior to designating the third instance of the database as the primary recipient of database queries from user computing devices.

3. The method of claim 1, further comprising:
repeatedly:
creating additional instances of the database,
encrypting the additional instances of the database with additional encryption keys,
synchronizing at least one of the additional instances of the database with an instance of the database that is designated as the primary recipient of database queries from user computing devices, and
after synchronizing the at least one of the additional instances, designating the at least one of the additional instances of the database as the primary recipient of database queries from user computing devices to provide uninterrupted access to at least one instance of the database for the user computing device.

4. The method of claim 3, further comprising waiting for a period of time to elapse between each iteration of creating additional instances of the database, in accordance with an encryption policy executed by the at least one computing device.

5. The method of claim 1 wherein synchronization of the second instance of the database with the first instance of the database includes making substantially all content of the second instance of the database the same as substantially all content of the first instance of the database.

6. The method of claim 1 wherein at least one of the first, second, and third instances of the database are hosted in remotely located computing environments that are only accessible to the user computing device by one or more external networks.

7. The method of claim 1 wherein the first instance of the database is stored in a first computing environment and the second instance of the database is stored in a second computing environment, wherein copying the first or second instance of the database includes:
creating a snapshot copy or other backup copy of the first or second instance of the database; and
restoring the snapshot copy or other backup copy of the first or second instance of the database to a third computing environment.

8. The method of claim 1 wherein designating the third instance of the database as the primary recipient of database queries from the user computing devices includes routing the database queries to the third instance of the database before the first and second instance of the database.

9. The method of claim 1, wherein the at least one computing device includes an encryption policy manager, wherein the method further comprises:
generating the second encryption key with the encryption policy manager;
generating a decryption key that is associated with the second encryption key and that enables decryption of information that has been encrypted with the second encryption key; and
transmitting the decryption key to the user computing devices to enable the user computing devices to decrypt at least part of the third instance of the database at the user computing devices.

10. The method of claim 1 wherein decommissioning the first instance of the database or the second instance of the database includes routing the database queries from the user computing devices to the third instance of the database.

11. A computer implemented method for automating database encryption updates, comprising:
establishing, with a policy manager computing device, a first instance of a database and a second instance of the database on one or more computing devices,
wherein the first instance of the database and the second instance of the database are encrypted with an old encryption key;
designating the first instance of the database as a primary instance of the database,
wherein the primary instance of the database receives database queries and database change information from a user computing device,
designating the second instance of the database as a mirror instance of the database,
wherein the mirror instance of the database is configured to synchronize with the primary instance of the database to provide a redundant instance of the primary instance of the database;
rotating encryption characteristics of the primary instance of the database and the mirror instance of the database by repeatedly:
copying the primary instance of the database or the mirror instance of the database to create a new instance of the database that is different than the primary instance of the database and that is different than the mirror instance of the database;
decrypting the new instance of the database from the old encryption key that was used to encrypt the primary instance of the database;
generating a new encryption key that is different than the old encryption key;
encrypting the new instance of the database with the new encryption key;
designating the new instance of the database as the primary instance of the database that receives database queries and database change information from the user computing device;
reassigning the new encryption key as the old encryption key; and
allowing a predetermined period of time to elapse in accordance with an encryption policy executed by the policy manager computing device.

12. The method of claim 11, further comprising:
synchronizing the new instance with the primary instance of the database prior to designating the new instance of the database as the primary instance of the database.

13. The method of claim 11 wherein copying the primary instance of the database or the mirror instance of the database to create the new instance of the database includes restoring a snapshot copy or other backup copy of the primary instance of the database or of the mirror instance of the database to one or more computing devices.

14. The method of claim 11 wherein rotating encryption characteristics of the primary instance of the database and the mirror instance of the database further includes:
transmitting the new encryption key to the user computing device to enable the user computing device to decrypt the primary instance of the database.

15. The method of claim 11 wherein rotating encryption characteristics of the primary instance of the database and the mirror instance of the database further includes:
creating a copy of the mirror instance of the database;
decrypting the copy of the mirror instance of the database;
encrypting the copy of the mirror instance of the database with the new encryption key; and
designating the copy of the mirror instance of the database as the mirror instance of the database.

16. A system for providing uninterrupted access to a database while rotating encryption keys to the database, the system comprising:
at least one processor; and
at least one memory coupled to the at least one processor, the at least one memory having stored therein instructions which when executed by any set of the one or more processors, perform a process for providing uninterrupted access to the database while rotating encryption keys to the database, the process including:
encrypting a first instance of the database with a first encryption key and a second instance of the database with the first encryption key,
wherein the second instance of the database is synchronized with the first instance of the database,
wherein the first instance of the database is designated as a primary recipient of database queries from user computing devices;
creating a third instance of the database by copying the first instance of the database or the second instance of the database,
wherein, upon creation, the third instance of the database includes contents that are encrypted with the first encryption key;
decrypting the third instance of the database to disassociate the contents of the third instance of the database from the first encryption key;
encrypting the third instance of the database with a second encryption key;
designating the third instance of the database as the primary recipient of database queries from user computing devices;
encrypting the first instance of the database or the second instance of the database with the second encryption key; and
decommissioning the first instance of the database or the second instance of the database that is not encrypted with the second encryption key.

17. The system of claim 16, further comprising:
synchronizing the third instance of the database with the first instance of the database prior to designating the third instance of the database as the primary recipient of database queries from user computing devices.

18. The system of claim 16, further comprising:
repeatedly:
creating additional instances of the database,
encrypting the additional instances of the database with additional encryption keys,
synchronizing at least one of the additional instances of the database with an instance of the database that is designated as the primary recipient of database queries from user computing devices, and
after synchronizing at least one of the additional instances, designating the at least one of the additional instances of the database as the primary recipient of database queries from user computing devices to provide uninterrupted access to at least one instance of the database for the user computing device.

19. The system of claim 16 wherein the process further comprises: waiting for a period of time to elapse between each iteration of creating additional instances of the database, in accordance with an encryption policy.

20. The system of claim 16 wherein synchronization of the second instance of the database with the first instance of the database includes making substantially all content of the second instance of the database the same as substantially all content of the first instance of the database.

21. The system of claim 16 wherein at least one of the first, second, third, and additional instances of the database are hosted in remotely located computing environments that are only accessible to the user computing device by one or more external networks.

22. The system of claim 16 wherein the first instance of the database is stored in a first computing environment and the second instance of the database is stored in a second computing environment, wherein copying the first or second instance of the database includes:
creating a snapshot copy or other backup copy of the first or second instance of the database; and
restoring the snapshot copy or other backup copy of the first or second instance of the database to a third computing environment.

23. The system of claim 16 wherein designating the third instance of the database as the primary recipient of database queries from the user computing devices includes routing the database queries to the third instance of the database instead of to the first or second instance of the database.

24. The system of claim 16, further comprising an encryption policy manager, wherein the process further includes:
generating the second encryption key with the encryption policy manager;
generating a decryption key that is associated with the second encryption key and that enables decryption of information that has been encrypted with the second encryption key; and
transmitting the decryption key to the user computing devices to enable the user computing devices to decrypt at least part of the third instance of the database at the user computing devices.

25. The system of claim 16 wherein decommissioning the first instance of the database or the second instance of the database includes routing the database queries from the user computing devices to the third instance of the database.

26. A system for automating database encryption updates, comprising:
at least one processor; and
at least one memory coupled to the at least one processor, the at least one memory having stored therein instructions which when executed by any set of the one or more processors, perform a process for automating database encryption updates, the process including:
establishing a first instance of a database and a second instance of the database on one or more computing devices,
wherein the first instance of the database and the second instance of the database are encrypted with an old encryption key;
designating the first instance of the database as a primary instance of the database,
wherein the primary instance of the database receives database queries and database change information from a user computing device,
designating the second instance of the database as a mirror instance of the database,
wherein the mirror instance of the database is configured to synchronize with the primary instance of the database to provide a redundant instance of the primary instance of the database;
rotating encryption characteristics of the database by repeatedly:
copying the primary instance of the database or the mirror instance of the database to create a new instance of the database;
decrypting the new instance of the database from the old encryption key that was used to encrypt the primary instance of the database;
generating a new encryption key that is different than the old encryption key;
encrypting the new instance of the database with the new encryption key;
designating the new instance of the database as the primary instance of the database that receives database queries and database change information from the user computing device;
reassigning the new encryption key as the old encryption key; and
allowing a predetermined period of time to elapse in accordance with an encryption policy.

27. The system of claim 26, further comprising:
synchronizing contents of the new instance of the database to contents of the primary instance of the database.

28. The system of claim 26 wherein copying the primary instance of the database or the mirror instance of the database to create the new instance of the database includes restoring a snapshot copy or other backup copy of the primary instance of the database or of the mirror instance of the database to one or more computing devices.

29. The system of claim 26 wherein rotating encryption characteristics of the database further includes:
transmitting the new encryption key to the user computing device to enable the user computing device to decrypt the primary instance of the database.

30. The system of claim 26 wherein rotating encryption characteristics of the database further includes:
creating a copy of the mirror instance of the database;
decrypting the copy of the mirror instance of the database;
encrypting the copy of the mirror instance of the database with the new encryption key; and
designating the copy of the mirror instance of the database as the mirror instance of the database.

31. A system for providing uninterrupted access to a database while rotating encryption keys to the database, the system comprising:
a first instance of a database, the first instance of the database being encrypted with a first encryption key;
a second instance of the database, the second instance of the database being encrypted with a first encryption key; the second instance of the database being synchronized with the first instance of the database;
at least one processor; and
at least one memory coupled to the at least one processor, the at least one memory having stored therein instructions which when executed by any set of the one or more processors, perform a process for providing uninterrupted access to the database while rotating encryption keys to the database, the process including:
designating the first instance of the database as a primary recipient of database queries from user computing devices;
creating a third instance of the database by copying the first instance of the database or the second instance of the database,
wherein, upon creation, the third instance of the database includes contents that are encrypted with the first encryption key;
decrypting the third instance of the database to disassociate the contents of the third instance of the database from the first encryption key;
encrypting the third instance of the database with a second encryption key;
designating the third instance of the database as the primary recipient of database queries from user computing devices;
encrypting the first instance of the database or the second instance of the database with the second encryption key; and
decommissioning the first instance of the database or the second instance of the database that is not encrypted with the second encryption key.

32. The system of claim 31, further comprising:
synchronizing the third instance of the database with the first instance of the database prior to designating the third instance of the database as the primary recipient of database queries from user computing devices.

33. The system of claim 31, further comprising:
repeatedly:
creating additional instances of the database,
encrypting the additional instances of the database with additional encryption keys,
synchronizing at least one of the additional instances of the database with an instance of the database that is designated as the primary recipient of database queries from user computing devices, and
after synchronizing the at least one of the additional instances, designating the at least one of the additional instances of the database as the primary recipient of database queries from user computing devices to provide uninterrupted access to at least one instance of the database for the user computing device.

34. The system of claim 31 wherein synchronization of the second instance of the database with the first instance of the database includes making substantially all content of the second instance of the database the same as substantially all content of the first instance of the database.

35. The system of claim 31 wherein at least one of the first, second, third, and additional instances of the database are hosted in remotely located computing environments that are only accessible to the user computing device by one or more external networks.

36. The system of claim 31 wherein the first instance of the database is stored in a first computing environment and the second instance of the database is stored in a second computing environment, wherein copying the first or second instance of the database includes:
creating a snapshot copy or other backup copy of the first or second instance of the database; and
restoring the snapshot copy or other backup copy of the first or second instance of the database to a third computing environment.

37. The system of claim 31 wherein designating the third instance of the database as the primary recipient of database queries from the user computing devices includes routing the database queries to the third instance of the database instead of to the first or second instance of the database.

38. The system of claim 31, further comprising an encryption policy manager, wherein the process further includes:
generating the second encryption key with the encryption policy manager;
generating a decryption key that is associated with the second encryption key and that enables decryption of information that has been encrypted with the second encryption key; and
transmitting the decryption key to the user computing devices to enable the user computing devices to decrypt at least part of the third instance of the database at the user computing devices.

39. The system of claim 31 wherein decommissioning the first instance of the database or the second instance of the database includes routing the database queries from the user computing devices to the third instance of the database.

40. The system of claim 31 wherein the process further comprises:
waiting for a period of time to elapse between each iteration of creating additional instances of the database, in accordance with an encryption policy.
